(19) United States
(12) Patent Application Publication
(10) Pub. No.: US 2010/0074681 A1
(43) Pub. Date: Mar. 25, 2010

(54) EQUIPMENT TRANSFER SYSTEM LATCHING MECHANISM

(76) Inventor: Shahriar Jamalzadeh, Richmond Hill (CA)

Correspondence Address: SEYFARTH SHAW LLP, 131 S. DEARBORN ST., SUITE 2400, CHICAGO, IL, 60603-5803, US

(21) Appl. No.: 12/236,712

(22) Filed: Sep. 24, 2008

(51) Int. Cl. F16B 21/07; F16B 21/18; H01R 4/60

(52) U.S. Cl. 403/327; 403/375; 439/211

(57) ABSTRACT

A latching assembly on a service column is configured to correspond to a latching assembly on a transport bracket so that the transport bracket may be automatically locked to the service column upon the establishment of a mechanical connection. Furthermore, a safety mechanism maintains the lock until, for instance, the transport bracket is installed on a hospital patient transport vehicle. Additionally, the transport bracket latching assembly is provided with flexibility to connect with the service column latching assembly even in the presence of an offset from an entirely vertical connection. A further element allows a transfer of AC power from the service column to the transport bracket.

### FIELD OF THE INVENTION

The present application relates generally to healthcare furniture and, more specifically, to a latching mechanism for use in connecting an equipment transfer system to a service column.

### BACKGROUND OF THE INVENTION

For very ill hospital patients, such as, for example, cardiac surgery patients, there is a great deal of equipment associated with their treatment. Much of this equipment will comprise infusion pumps and intravenous solutions. In U.S. Pat. No. 4,901,967, issued Feb. 20, 1990 to Petre (hereinafter “Petre”), a patient equipment transport and support system is disclosed to transport equipment that is in operative use by a patient, along with the patient over long distances through a hospital, across elevator thresholds or around hallway corners. Petre acknowledges that frequently, several nurses are required to handle the transport of the patient and the equipment. Some nurses will be moving the bed containing the patient, other nurses would be pushing IV stands and other equipment support devices. The number of people involved, the instability of some of the equipment support systems during rolling movement and normal path obstacles such as elevator thresholds have all combined to make it troublesome and difficult for the movement of the patient and equipment when moving the patient to and from an operating room or from and to an intensive care unit or a patient holding area.

As a solution, Petre suggests a selectively transportable equipment support system for operative association with an invalid transport vehicle. The system includes a transport bracket for selective secured association with a hospital bed or a service column. Various patient care items may be secured to the transport bracket. The transport bracket includes a pivot post for reception in a service column latching assembly, which allows pivotable movement of the transport bracket when the transport bracket is secured to a service column support arm.

The Applicant has recognized room for improvement in the manner in which the equipment support system disclosed in Petre connects to the service column.

### SUMMARY

A latching assembly on a service column is configured to correspond to a latching assembly on a transport bracket so that the transport bracket may be automatically locked to the service column upon the establishment of a mechanical connection.

In accordance with an aspect of the present invention there is provided a latching assembly for automatically locking a transport bracket to a service column. The latching assembly includes a service column latching assembly and a transport bracket latching assembly. The service column latching assembly includes a male coupling depending from the service column, a coupling insert depending from the male coupling, the coupling insert defining an aperture extending from a coupling insert interior to a coupling insert exterior and a retaining element moveably retained within the aperture. The transport bracket latching assembly includes a tubular cage having an interior groove and a latch positioned inside the cage so that the, upon insertion of the latch into the coupling insert interior, the latch forces the retaining element into the interior groove to maintain attachment of the transport bracket latching assembly to the service column latching assembly.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

Reference will now be made to the drawings, which show by way of example, embodiments of the invention, and in which:

FIG. 1 illustrates a service column attached to a transport bracket according to an aspect of the present invention;

FIG. 2 illustrates a hospital bed attached to the transport bracket of FIG. 1 by way of a bracket support, with the transport bracket attached to service column of FIG. 1;

FIG. 3 illustrates the hospital bed of FIG. 2 attached to the transport bracket of FIG. 1, with the transport bracket detached from the service column of FIG. 1;

FIG. 4 illustrates an upper portion of the transport bracket of FIG. 1 detached from a lower portion of the service column of FIG. 1;

FIG. 5 illustrates, in section, the upper portion of the transport bracket attached to the lower portion of the service column;

FIG. 6 illustrates the transport bracket of FIG. 1 attached to the bracket support of FIG. 2, with the bracket support detached from the hospital bed;

FIG. 7 illustrates the bracket support of FIG. 2 detached from the hospital bed and the transport bracket of FIG. 1;

FIG. 8 illustrates, in section, the bracket support of FIG. 7;

FIG. 9 illustrates, in section, the lower portion of the transport bracket attached to the bracket support; and

FIG. 10 illustrates the section of FIG. 5 accommodating an offset from vertical.

### DETAILED DESCRIPTION OF THE EMBODIMENTS

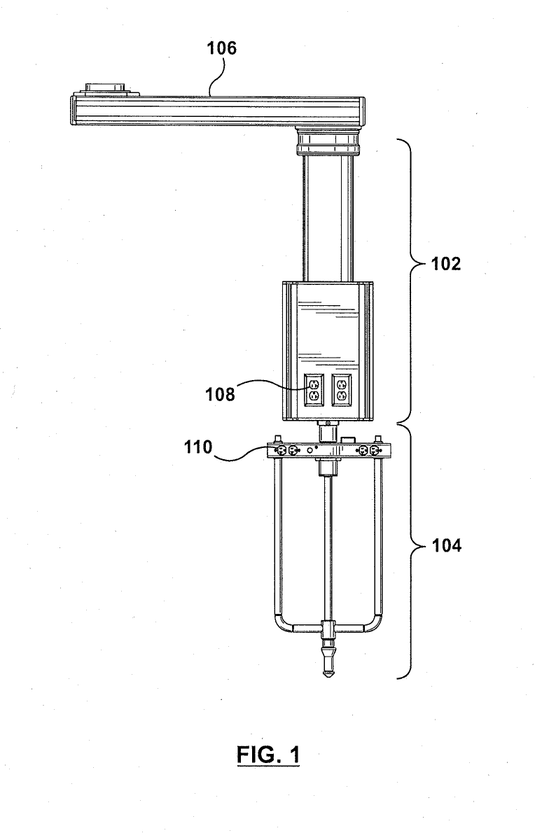

FIG. 1 illustrates a service column 102 connected to a transport bracket 104. The service column 102 is supported by a service arm 106 and the service arm 106 is generally attached to the ceiling (not shown) of a hospital room. The service column 102 includes electrical and gas outlets, an example one of which is indicated with reference numeral 108. The transport bracket 104 also includes electricity outlets, an example one of which is indicated with reference numeral 110.

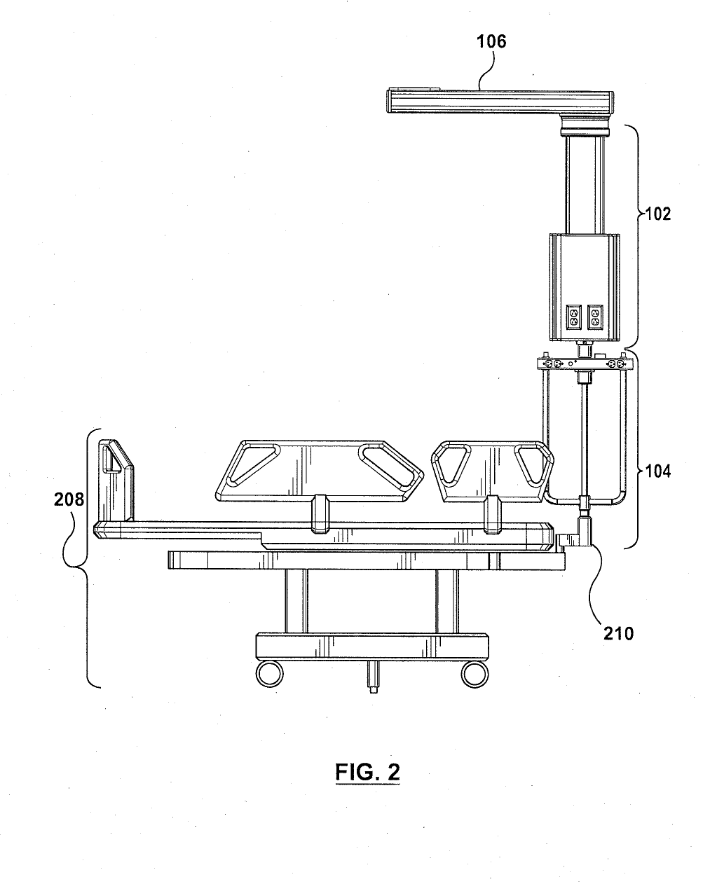

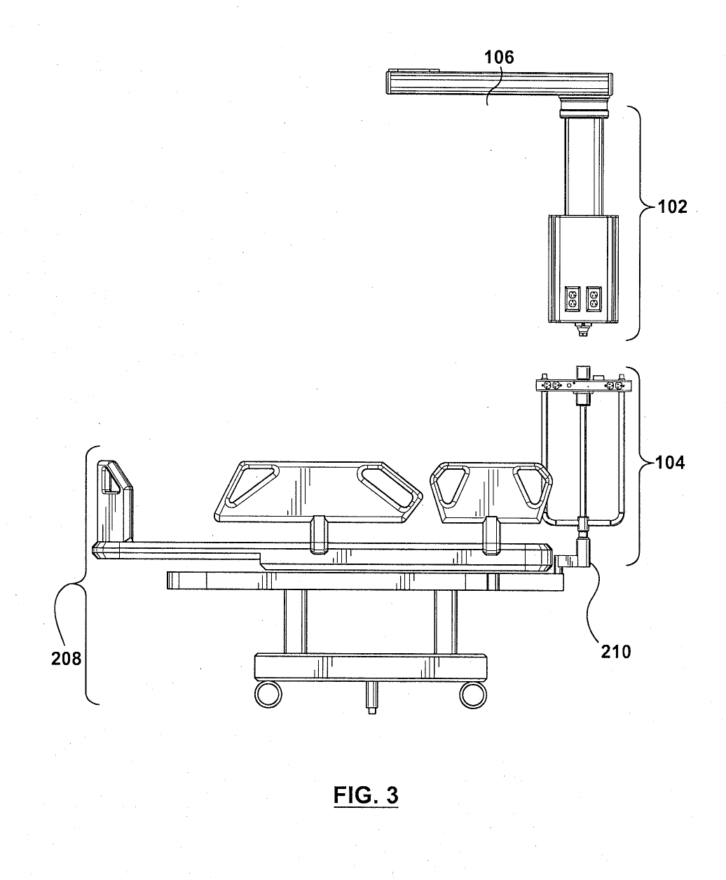

In FIG. 2, a hospital bed 208 is illustrated in conjunction with the components illustrated in FIG. 1. In particular, the transport bracket 104 is attached to the hospital bed 208 at a bracket support 210 in addition to being attached to the service column 102. FIG. 3 differs from FIG. 2 in that the transport bracket 104 is detached from the service column 102.

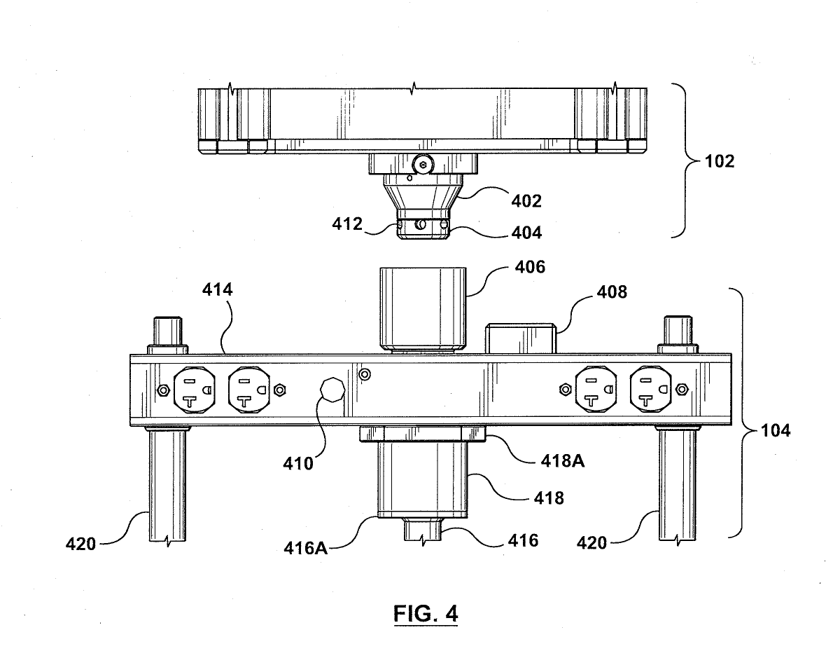

FIG. 4 illustrates an upper portion of the transport bracket 104 detached from a lower portion of the service column 102. A service column latching assembly, depending from the lower portion of the service column 102, includes a frustoconical male coupling 402, which receives, into an internally threaded hollow interior, a coupling insert 404. The coupling insert 404 is hollow and generally cylindrical and includes, in a lower portion a plurality of retaining element cavities 412. The retaining element cavities 412 retain retaining elements (not shown). The retaining elements may, for example, be ball bearings.

The upper portion of the transport bracket 104 features a hollow rectangular housing tube 414, from which depends a central post 416 and two peripheral posts 420. The central post 416 is attached, at a flanged portion 416A, to a bearing housing 418, which is attached, at a flanged portion 418A, to the housing tube 414.

For connection of the transport bracket 104 to the service column 102, the assembled male coupling 402 and coupling insert 404 are received by a collar 406. An indicator light 410 is provided for indicating that the connection of the transport bracket 104 to the service column 102 is complete. To facilitate detachment of the assembled male coupling 402 and coupling insert 404 from the collar 406, the transport bracket 104 includes a release button 408.

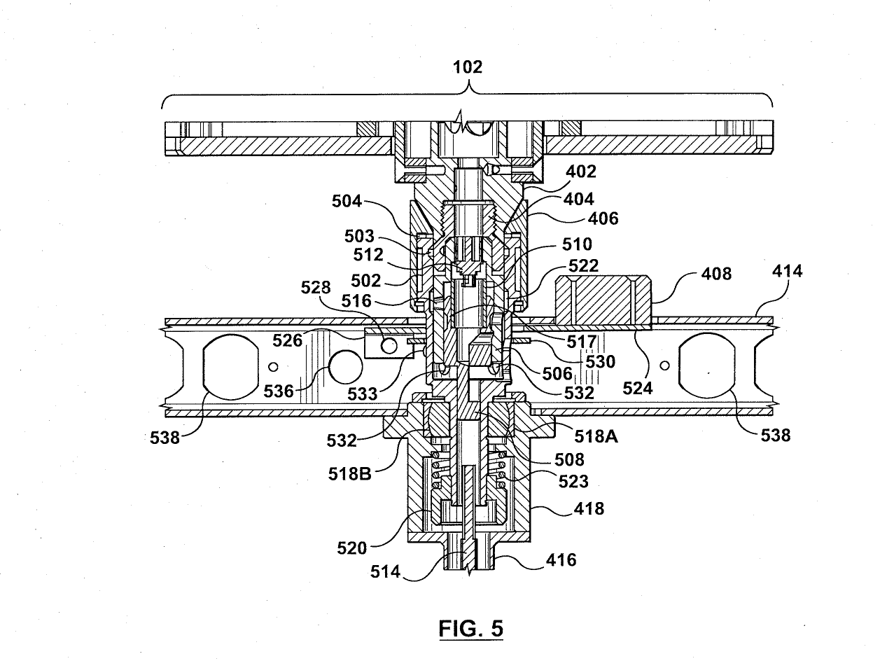

In view of FIG. 5, which illustrates a sectional view of the connection of the transport bracket 104 to the service column 102, it may be noted that the collar 406 defines a frustoconical top opening corresponding to the shape of the male coupling 402 of the service column 102. Furthermore, the collar 406 defines a cylindrical lower opening with a diameter smaller that the diameter of the lower end of the frustoconical top opening of the collar 406, such that a top end of the lower opening in the collar 406 is defined. The collar 406 surrounds a top portion of a transport bracket latching assembly. The collar 406 rests upon a generally cylindrical cage 502, an upper portion of which is received within the lower opening in the collar 406.

The cage 502 is supported by the bearing housing 418. In fact, the collar 406 does not rest directly upon the cage 502, instead, the top end of the lower opening in the collar 406 is separated from a top end of the cage 502 by a wave spring 504.

The upper portion of the cage 502, whose outer diameter corresponds to the inner diameter of the lower opening of the collar 406, also defines a generally cylindrical opening with an inner diameter. The cage 502 also has a lower, hollow and generally cylindrical portion.

The opening in the upper portion of the cage 502 is sized to receive a generally cylindrical, hollow latch 506. The interior of an upper portion of the latch 506 supports a female electrical connector 512. The exterior of the upper portion of the latch 506 is sized to fit inside an opening in the bottom of the coupling insert 404. A lower portion of the latch 506 surrounds a safety mechanism 508. The safety mechanism 508 extends down from the interior of the latch 506 into the interior of the lower portion of the cage 502. Furthermore, the safety mechanism 508 is biased downward by a safety spring 510.

The latch 506 includes cavities for ball bearings (not shown). An example cavity is identified in FIG. 5 by reference numeral 516. The cage 502 includes a lower annular groove 522 in the interior wall of the upper portion of the cage 502. Ball bearings (not shown), which are housed in the cavities 516 in the latch 506, may be forced by the safety mechanism 508 into the lower annular groove 522 in the interior wall of the upper portion of the cage 502 when the safety mechanism 508 is in a LOCKED position. When the safety mechanism 508 is in an UNLOCKED position, the ball bearings may be allowed to be partly in the cavities 516 in the latch 506 and partly in an annular groove 517 on the outer wall of the safety mechanism 508.

A generally cylindrical upper opening in the bearing housing 418 is sized to fit the outer diameter of an outer ring 518A of a self-aligning bearing. The self-aligning bearing also has an inner ring 518B through which passes the lower portion of the cage 502. The self-aligning bearing may be, for example, part no. 2204 ETN9 from AB SKF of Göteborg, Sweden. As will be clear to a person of ordinary skill in the art, the self-aligning bearing may be constructed with the inner ring 518B and a ball assembly (not shown) contained within the outer ring 518A, where the outer ring 518A has a spherical raceway. This construction allows the self-aligning bearing to tolerate a small angular misalignment resulting from deflection or improper mounting.

Within the bearing housing 418, at the lower end of the cage 502, a hollow, generally cylindrical movement limiter 520 has an inner diameter sized to fit the outer diameter of the lower portion of the cage 502. Furthermore, a vertical-alignment spring 523 is installed between the movement limiter 520 and the inside of the bearing housing 418.

Extending up though the hollow core of the central post 416 is a central pin 514. The central pin 514 also passes through the movement limiter 520 and into the inside of the lower portion of the cage 502.

The release button 408 is attached to a release plate 524 within the housing tube 414.

The release plate 524 extends along the top inside wall of the housing tube 414 to a position on the opposite side of the cage 502, where a flap 526 downwardly dependent from the release plate 524 allows for a pivoting attachment, by way of a pivot pin 528, of the release plate 524 to a side wall of the housing tube 414.

In close proximity to the portion of the cage 502 passed by the release plate 524, a release ring 530 surrounds the cage 502. For reasons that will become apparent hereinafter, at least one screw 533 is installed in the outer wall of the lower portion of the latch 506, below the release ring 530. To accommodate the screw 506 protruding from the lower portion of the latch 506, the cage 502 has a screw-movement aperture 532. The screw-movement aperture 532 may, for example, be oblong-shaped and allow the latch 506 a predetermined range of up and down movement within the cage 502.

The housing tube 414 is illustrated as including a plurality of apertures. Such apertures may, for instance, includes an indicator light aperture 536 through which the indicator light 410 may be visible. Additionally, a plurality of electrical outlet apertures 538 are also provided, to allow the transport bracket electrical outlets 110 to be accessible through the housing tube 414.

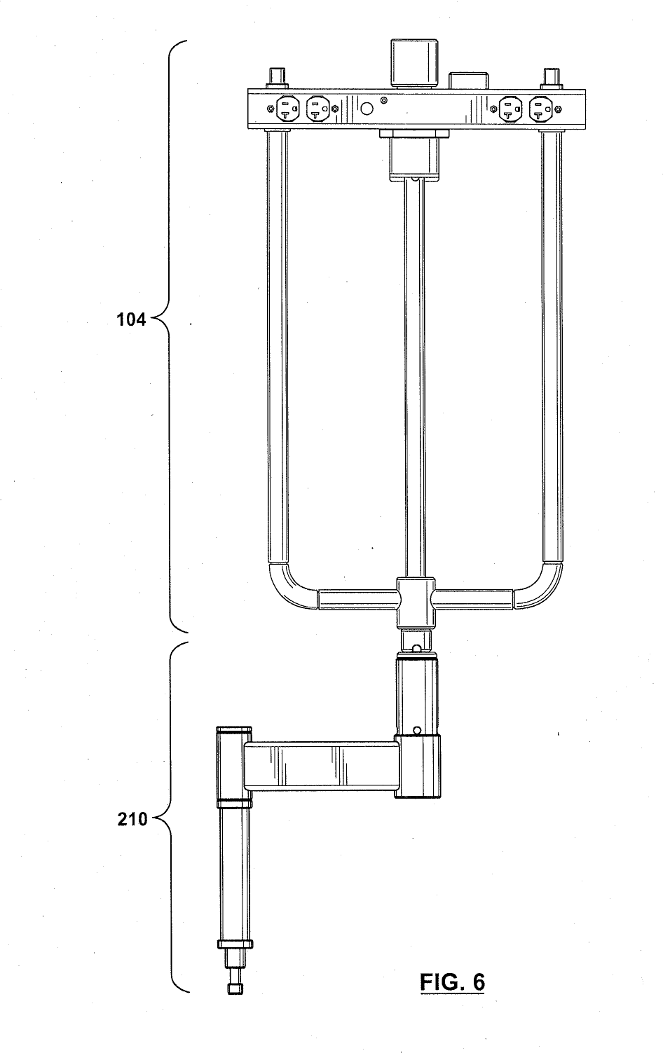

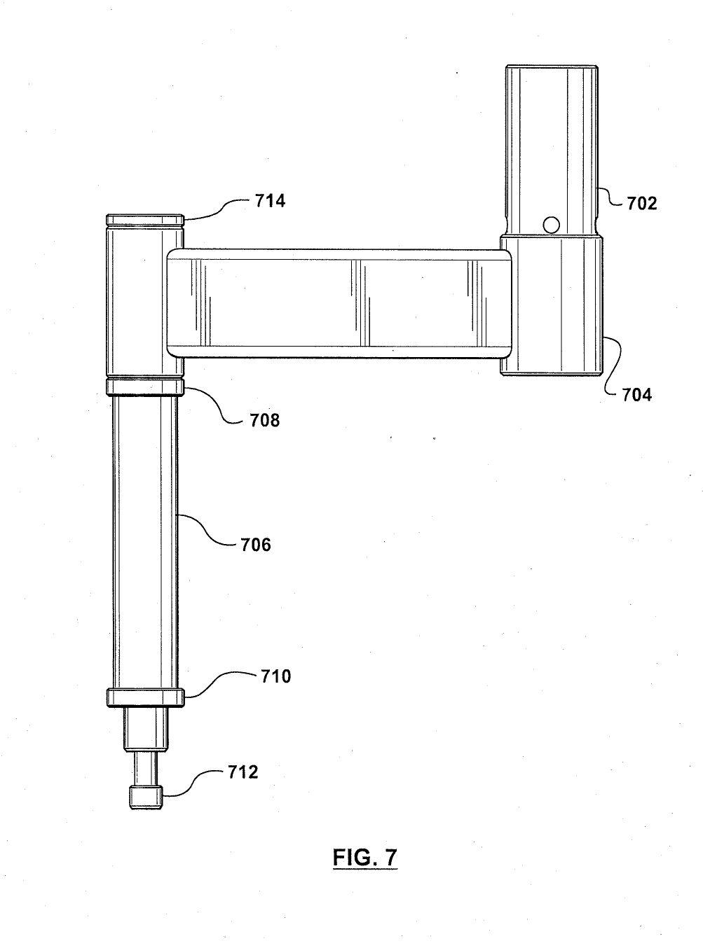

FIG. 6 illustrates the transport bracket 104 attached to the bracket support 210, with the bracket support 210 detached from the hospital bed 208. In FIG. 7, the bracket support 210 is illustrated detached both from the hospital bed 208 and from the transport bracket 104. The bracket support 210 includes a transport bracket support column 702 received within a distal end of a support arm 704. The proximal end of the support arm 704 receives a tubular bed frame insert 706. Each end of the bed frame insert 706 is received by a bearing. The upper end of the bed frame insert 706 is received by a support arm bearing 708, while the lower end of the bed frame insert 706 is received by a bed frame bearing 710. Protruding from the bottom of the bed frame bearing 710 is a bed frame attachment bolt 712. Topping the proximal end of the support arm 704 is a cap 714.

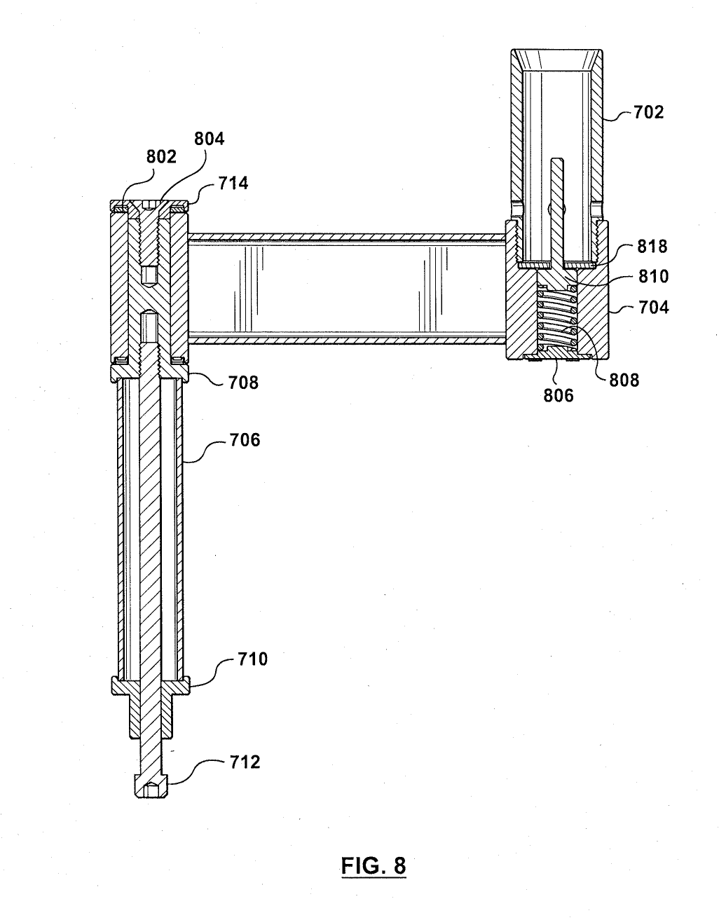

The structure of the bracket support 210 may be better understood in review of the sectional view in FIG. 8. As illustrated in FIG. 8, the transport bracket support column 702 is a hollow tube with an inwardly tapered top opening. The bottom end of the transport bracket support column 702 has an external thread for attachment to an internal thread in the distal end of the support arm 704. The distal end of the support arm 704 defines a passage having two sections. An upper section has the previously mentioned internal thread. A lower section receives a base of an unlocking pin 810. The unlocking pin 810 has an upstanding extension that extends into the upper section of the distal end of the support arm 704 through an o-ring 812. An unlocking pin spring 808, positioned in the lower portion of the distal end of the support arm 704, biases the unlocking pin 810 toward the upper portion of the distal end of the support arm 704. A spring retainer 806 maintains the unlocking pin spring 808 within the lower portion of the distal end of the support arm 704.

The proximal end of the support arm 704 defines a passage in which is received the support arm bearing 708. The support arm bearing 708 defines an internally threaded recess at each end. At a top end of the support arm bearing 708, the internally threaded recess receives a locking screw 804. The locking screw 804 passes through an aperture in the cap 714 and, when tightened, biases a sealing ring 802 against the proximal end of the support arm 704. The sealing ring 802 ring may, for instance, be formed of Teflon™. At a bottom end of the support arm bearing 708, the internally threaded recess receives the bed frame attachment bolt 712.

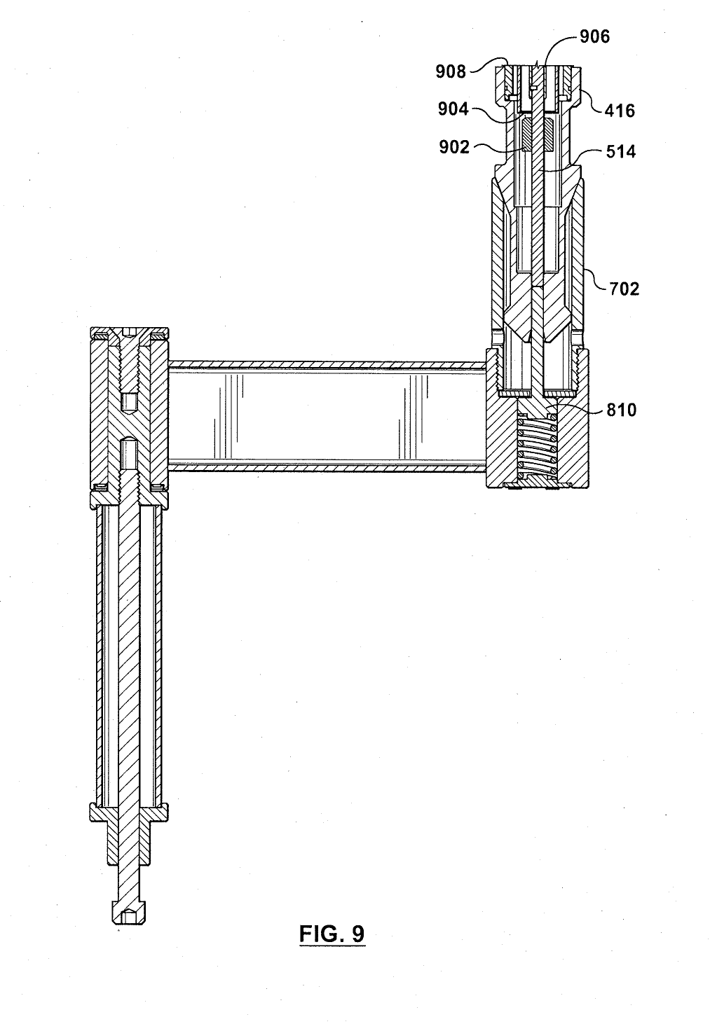

FIG. 5 illustrates a top end of the central post 416 with a corresponding top end of the central pin 514. FIG. 9 illustrates a bottom end of the central post 416 with a corresponding bottom end of the central pin 514. When the central post 416 has been received within the transport bracket support column 702, the unlocking pin 810 is received within a correspondingly sized and shaped passage within the bottom end of the central post 416.

Extending through the central post 416 are several bearings. A central pin spring 906 fits the external dimension of the central pin 514. At times, the central pin spring 906 biases against a spacer 902 to provide a cushioning when manually attaching the transport bracket 104 to the service column 102. A linear 908 fits the internal dimension of the central post 416. An intermediate bearing 904 is positioned between central pin bearing 906 and the central post bearing 908.

In overview, the transport bracket 104 may be attached to the service column 102 by arranging the transport bracket 104 so that the assembled male coupling 402 and coupling insert 404 are received within the collar 406. Through the combined action of the cage 502, the latch 506 and the coupling insert 404, the transport bracket 104 automatically locks to the service column 102, in contrast with known transport brackets for which manual effort is required to lock the transport bracket to a service column.

In operation, the central post 416 and the two peripheral posts 420 of the transport bracket 104 may support a plurality of patient care equipment. An example of such patient care equipment is an infusion pump with associated fluid bag. An infusion pump may be arranged to provide a patient with a regular, metered dose of a particular fluid or medication. It should be appreciated that the transport bracket 104 is in no way limited to only carrying infusion pumps and related equipment.

As the coupling insert 404 is received between the cage 502 and the latch 506, the latch 506 is received in the bottom opening in the coupling insert 404. The presence of the latch 506 in the bottom opening in the coupling insert 404 forces the ball bearings (not shown), retained in retaining element cavities 412 in the coupling insert 404, into an upper annular groove 503 in the interior wall of the upper portion of the cage 502 thereby locking the cage 502 to the coupling insert 404 and, accordingly, locking the transport bracket 104 to the service column 102. The resulting arrangement of the transport bracket 104 locked to the service column 102 is illustrated in FIG. 1.

An operator of the equipment transfer system may bring the hospital bed 208 proximate to the arrangement of the transport bracket 104 locked to the service column 102 is illustrated in FIG. 1. The bottom of the central post 416 of the transport bracket 104 may then be received by the transport bracket support column 702 of the bracket support 210 attached to the hospital bed 208. The resulting arrangement of the transport bracket 104 locked to the service column 102 and attached to the hospital bed 208 is illustrated in FIG. 2.

Once the transport bracket 104 has been attached to the bracket support 210 attached to the hospital bed 208, the operator may wish to disconnect the transport bracket 104 from the service column 102 to obtain the arrangement of the transport bracket 104 detached from the service column 102 and attached to the hospital bed 208, as illustrated in FIG. 3.

To release the cage 502 from the coupling insert 404, the latch 506 may be removed from the bottom opening in the coupling insert 404, thereby allowing the ball bearings to retract out of the upper annular groove 503 in the interior wall of the upper portion of the cage 502 and into the coupling insert 404 so that the coupling insert 404 may be removed from the cage 502.

However, the latch 506 is not easily removed from the bottom opening in the coupling insert 404. When the latch 506 is in position in the bottom opening in the coupling insert 404, the safety mechanism 508, in the interior of the bottom end of the latch 506, forces ball bearings, which are housed in the cavities 516 in the latch 506, into the lower annular groove 522 in the interior wall of the upper portion of the cage 502. Such a position of the safety mechanism 508 may be called the LOCKED position.

The safety mechanism 508 may be forced upward by the central pin 514. Indeed, the safety mechanism 508 may be forced upward to the point at which the ball bearings may be allowed to retract out of the lower annular groove 522 in the interior wall of the upper portion of the cage 502 and into the cavities 516 in the latch 506 and the annular groove 517 on the outer wall of the safety mechanism 508. Such a position of the safety mechanism 508 may be called the UNLOCKED position.

The unlocking pin 810 of the bracket support 210 on the hospital bed 208 may be arranged to force the central pin 514 upward, responsive to the bottom of the central post 416 being received within the transport bracket support column 702, resulting in the safety mechanism 508 being forced upward into the UNLOCKED position.

Even with the safety mechanism 508 in the UNLOCKED position, the cage 502 remains locked to the coupling insert 404 so long as the latch 506 remains within the coupling insert 404.

To remove the latch 506 from the interior of the coupling insert 404, an operator of the equipment transfer system may depress the release button 408. Depressing the release button 408 causes the release plate 524 to pivot on the pivot pin 528 and angle downwardly, thereby applying a downward force on the release ring 530. The downward force on the release ring 530 translates to a downward force on the screw 533, which, in turn, translates to a downward force on the latch 506.

Once the latch 506 has been removed from the interior of the coupling insert 404, the assembled male coupling 402 and coupling insert 404 may be removed from within the collar 406.

The removal, from within the collar 406, of the assembled male coupling 402 and coupling insert 404 detaches the transport bracket 104 from the service column 102 to obtain the arrangement of the transport bracket 104 detached from the service column 102 and attached to the hospital bed 208, as illustrated in FIG. 3.

The hospital bed 208, with attached transport bracket 104 and patient care equipment (not shown) may then be moved from proximity to the service column 102, for instance, in a patient room, to proximity to another service column, for instance, in a surgical room.

Upon arrival at the surgical room, the equipment transfer system operator may attempt to insert a service column latching assembly into the collar 406 of the transport bracket 104.

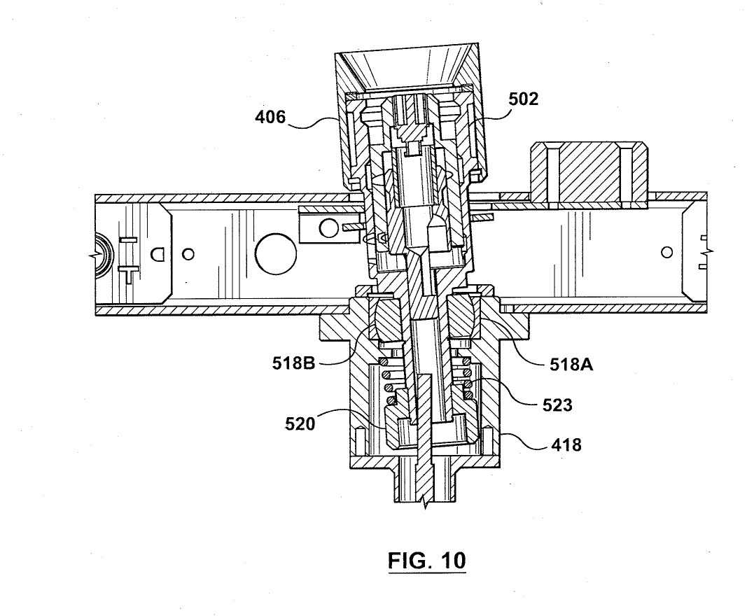

The operator may not be entirely accurate with the attempt to insert the service column latching assembly into the collar 406. However, according to one embodiment, the transport bracket 104 can accommodate small offsets. In particular, the self-aligning bearing 518A, 518B allows (see FIG. 10) a displacement from vertical of the cage 502 and, consequently, all of the contents of the cage 502. The extent to which the cage 502 may be vertically displaced is limited by the movement limiter 520 installed at the bottom of the cage 502. When the cage 502 has been displaced from vertical, the vertical-alignment spring 523 is compressed, on one side, between the movement limiter 520 and the inside of the bearing housing 418. As a consequence of this compression, the vertical-alignment spring 523 biases the cage 502 back to vertical.

Patient care equipment that may be supported by any of the central post 416 and the two peripheral posts 420 of the transport bracket 104 may require alternating current (AC) power traditionally supplied by the service column 102.

An advantageous feature of the transport bracket 104 is a provision of AC power much closer to the patient care equipment, that is, the electricity outlets 110 on the housing tube 414. AC power is supplied to the electricity outlets 110 on the housing tube 414 when the transport bracket 104 is connected to the service column 102. In particular, a male electrical connector (not shown) is surrounded by the assembled male coupling 402 and coupling insert 404. The male electrical connector receives power from within the service column 102 and, upon connection to the transport bracket 104, mates with the female electrical connector 512 to form an electrical connection. From the female electrical connector 512, electrical cabling (not shown) distributes the AC power to the transport bracket electricity outlets 110.

Notably, patient care equipment is often arranged to operate both on AC power and on direct current (DC, i.e., battery) power. The patient care equipment battery generally charges when the patient care equipment is connected to a source of AC power so that the DC power is available to operate the patient care equipment when the transport bracket 104 has been disconnected from the service column 102, say, for patient transport from a surgical room to a recovery room.

While, in the foregoing description, the bracket support 210 has been attached to the hospital bed 208, it will be appreciated that the bracket support 210 may be attached to other structures, according to need.

The above-described embodiments of the present application are intended to be examples only. Alterations, modifications and variations may be effected to the particular embodiments by those skilled in the art without departing from the scope of the application, which is defined by the claims appended hereto.

We claim:

1. A latching assembly for automatically locking a transport bracket to a service column, said latching assembly comprising:
a service column latching assembly including:
a male coupling depending from said service column;
a coupling insert depending from said male coupling, said coupling insert defining an aperture extending from a coupling insert interior to a coupling insert exterior; and
a retaining element moveably retained within said aperture; and
a transport bracket latching assembly including:
a tubular cage having an interior groove; and
a latch positioned inside said cage so that said, upon insertion of said latch into said coupling insert interior, said latch forces said retaining element into said interior groove to maintain attachment of said transport bracket latching assembly to said service column latching assembly.

2. The latching assembly of claim 1 wherein said retaining element comprises a ball bearing.

3. The latching assembly of claim 1 wherein said cage has a further interior groove and said latch defines a latch aperture extending from a latch interior to a latch exterior, said latching assembly further comprising:
a further retaining element moveably retained within said latch aperture; and
a safety mechanism received in said latch interior, said safety mechanism having:
a first position, in which a position of said latch relative to said cage is maintained through forcing, by said safety mechanism, of said further retaining element into said further interior groove; and
a second position, in which said further retaining element is allowed to project into said interior of said latch, thereby releasing said latch to move freely within said cage.

4. The latching assembly of claim 3 wherein said transport bracket includes a central post surrounding a central pin such that, responsive to attachment of said central post to a bracket support, said central pin forces said safety mechanism into said second position.

5. The latching assembly of claim 3 further comprising a biasing element biasing said safety mechanism in said first position.

6. The latching assembly of claim 5 wherein said biasing element comprises a spring.

7. The latching assembly of claim 1 wherein said transport bracket includes a bearing housing and said cage is maintained in an inner ring of a self-aligning bearing, where an outer ring of said self-aligning bearing is maintained by said bearing housing, said self-aligning bearing allowing for an attitude of said cage to vary from vertical.

8. The latching assembly of claim 7 further comprising a movement limiter mounted at a bottom end of said cage to bear against said bearing housing thereby limiting extremes of variation from vertical of said attitude of said cage.

9. The latching assembly of claim 7 further comprising a biasing element to bias said cage toward a vertical attitude.

10. The latching assembly of claim 1 further comprising:
a service column electrical connector mounted within said service column latching assembly; and
a transport bracket electrical connector mounted within said transport bracket latching assembly, said transport bracket electrical connector configured to connect to, and receive alternating current power from, said service column electrical connector.
